(19) United States
(12) Patent Application Publication
(10) Pub. No.: US 2009/0214018 A1
(43) Pub. Date: Aug. 27, 2009

(54) Distributed identifier management

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/317,505

(22) Filed: Dec. 26, 2008

Related U.S. Application Data
(60) Provisional application No. 61/066,617, filed on Feb. 21, 2008.

(51) Int. Cl. H04M 7/00; H04L 12/66

(52) U.S. Cl. 379/220.01; 370/352

(57) ABSTRACT

An overlay network of volatile nodes, without centralized servers, using DHT-like search algorithms, is programmed to perform One-Number or One-ID services. A user's public number is either the PSTN or PLMN line that is connected to an overlay node, or a voice (or video) over IP number, which is serviced through the overlay. An overlay node is connected to the Internet, and may connect to a PSTN or PLMN phone line as well. The phone numbers allowed in the One-Number service is generally defined. The One-ID service architecture is based on user-proxy, and does not require social networking other one-ID protocols such as OpenID and protocols suites drafted by OASIS. The user-ID of such a One-ID service is not required to be globally unique while a mapping is used to transform a user-defined non-globally unique ID into a site-specific and site-unique ID.

### CROSS REFERENCE TO RELATED APPLICATION

This application claims the benefit of U.S. Provisional Patent Application Ser. No. 61/066,617, filed Feb. 21, 2008, the disclosure of which is herein expressly incorporated by reference.

### FIELD OF THE INVENTION

The present invention relates in general, to the management of multiple telecommunication identifiers of an individual, and more particularly, to a distributed implementation of One-Number calling and One-ID services for individuals.

### BACKGROUND OF THE INVENTION

The complexity of modern life makes the use of multiple telecommunication identifiers a necessity. To suit different purposes, an individual often has multiple identifiers, each identifier corresponding to a particular mode of communication.

Modern telecommunication modes can be categorized into text, voice, video, and hybrids. In the category of text, emails and instant messaging are prominent examples. In the category of voice, fixed phones, mobile phones, and VoIP phones (PC-to-PC, phone-to-PC and other forms) are prominent examples. Then there are video phones, Web blogs, and other hybrid modes of telecommunication.

Yet another categorization is based on human-human and human-machine interactions. An individual can interact with a Web site by logging into a site, browsing, and conducting transactions with the site; such is an example of human-machine telecommunication. This categorization is not perfect, as two individuals can communicate through a Web site; for example, emails, VoIP calls, video calls, and instant messaging can all be conducted through a Web site.

There are multiple dimensions of modern life that necessitate different modes of telecommunication. These dimensions include costs, time, availability, locality, privacy, and convenience.

Cost is often a significant concern. For cellular phones, costs are highly dependent on the time and the correspondent of a call. For example, air-time charges are waived in the US for off-peak hours (after 9 PM, before 7 AM, and weekends), and for a conversation between two subscribers within the same service provider.

Another consideration is availability. A cellular voice service is constrained by circuit availability, coverage, and battery power. For fixed phones, a main constraint is the physical location of an individual. For example, if an individual is physically out of his office, then his office desk phone becomes unavailable.

Other considerations include privacy and convenience. A User may deem certain channels such as a public Wi-Fi link to be unsecure depending on the message he wants to send or receive. Likewise, a mobile user may simply decide to use his cell phone rather than a softphone on a PC for convenience.

For these considerations, an individual often uses different accounts (for VoIP, email, and online presence) to communicate with different correspondents.

For practical purposes, not all potential correspondents may be aware of all possible identifiers, and may not choose best modes of communication.

Therefore, it is desirable for an individual to manage his preferred modes of communication using different identifiers, for a variety of reasons.

The present invention deals with two aspects of identifier management of an individual in the Internet era. The first is related to a service using phone numbers as identifiers (called a One-Number or 1N service), the second is related to login IDs as identifiers (called a One-ID or 1D service). A 1N service based on the present invention will be referred to as a grassnode 1N service, and a 1D service based on the present invention will be referred to as a grassnode 1D service.

A One-Number (1N) service allows a subscriber to be reachable with multiple voice identifiers, such as home phone numbers, work phone numbers, cellular phone numbers, or VoIP numbers. A good example of 1N service is offered by GrandCentral, a startup company acquired by Google in 2007.

In a typical 1N service, a subscriber would disclose to his contacts a single public phone number, called a PN (public number). The only requirement for a PN is that it uniquely identifies a subscriber. Then by means of network protocols, when a caller dials a PN, automatically all devices registered by the subscriber under the PN will ring simultaneously. This allows the subscriber to pick up a most suitable device at the time of the call.

Current solutions offering 1N of service use a centralized infrastructure. In this type of implementation, main costs are associated with the acquisition of a pool of public phone numbers (PNs) and the costs of maintaining PSTN (public switched telephone network) lines between the public numbers and the subscriber-registered phone numbers. These costs represent capital expenditure (CapEx) and operating expenditure (OpEx) in the business.

A grassnode 1N service is differentiated by providing a completely decentralized infrastructure without any servers. The decentralized infrastructure will reduce dramatically CapEx and OpEx of the 1N service. A grassnode 1N service does not require a new phone number to be used as the PN for an individual.

The second service related to the present invention is a One-ID (1D) service. This service has become a killer application recently. Most people now have to remember numerous accounts (account names and passwords) at all kinds of Web sites, and to keep track of all of them is a major headache. In the past few years, social networking (Web 2.0) has become tremendously popular. At each new social networking site, an individual often has to do the following: re-create an account, re-enter a profile, re-find his friends, and re-establish relationships, etc. In sum, at a new site, three categories of information must be established: (1) who I am, (2) whom I know, (3) what is going on. This can be done either by tediously re-establish a silo, or make a widget (portable chunk of code that can be installed and executed within any Web page without compilation). Therefore, an urgent need is to simplify login and profile information entry.

Furthermore, pervasive attacks on security and privacy through the many accounts an individual owns make the problem even more unbearable. A popular solution is that of OpenID, which allows an individual to use an existing account to login to another account. In fact, a whole hosts of services and protocols have been set up to solve these and related problems. A good source of such information can be found in the industry consortium OASIS (Organization for the Advancement of Structured Information Standards).

A grassnode 1D service is one that provides at least one of the following sub-services: (1) allowing a subscriber to use one user-defined account (username with password) to login (sign on) to a plurality of sites; (2) automatic registration (sign-up) of a subscriber to a new site; (3) automatic transferring of subscriber information (such as contact lists, activity lists, history, etc.) to a site.

The first difference between an OpenID and grassnode 1D services is on the service architecture. Effectively, the OpenID architecture is that of server proxy—to authenticate a user login, a site uses a proxy server; such a system is often called a reverse proxy system. On the other hand, in a grassnode 1D service, a user uses a user-proxy to be authenticated in a site login. The OpenID reverse proxy architecture is depicted in FIG. 6, whereas the grassnode 1D user proxy architecture is depicted in FIG. 7.

The second difference between an OpenID and a grassnode 1D services is on protocol compatibility. To use an OpenID service at a Web site, the site must support OpenID; on the other hand, there is no such requirement for a grassnode 1D service. While OpenID today enjoys the support of major companies such as Google, Microsoft, Yahoo, and AOL, with 150 million registered users, it is still highly probable that an OpenID user encounters a Web site that does not support OpenID. On the other hand, a user of grassnode 1D service will be able to login to practically all Web sites, regardless the site supports the 1D service or not.

A limiting constraint on a grassnode 1D service is that the service must program its software to conduct login and profile transfer to desired sites—different sites may use different login processes and profile transfer processes, while some may disallow profile transfer altogether. Such a limitation is much smaller in scope than the requirement that a site must support OpenID.

There is a drawback associated with a grassnode 1D service. In the OpenID case, between a Web site and an OpenID provider, profile information transfer is quite easy, because both parties in the transfer comply with the same protocol standards and formats (OpenID and other protocol suites from OASIS). However, a grassnode 1D service provider may not be able to transfer user profiles in a simple way to an arbitrary site, as there are no agreed-upon protocols for making such a transfer.

A third difference between an OpenID and a grassnode 1D services is that an OpenID service provider needs to erect an infrastructure with servers while a grassnode 1D provider will utilize a serverless infrastructure using DHT (distributed hash table) based search algorithms.

### BRIEF SUMMARY OF THE INVENTION

It is, therefore, an object of the present invention to provide methods to enable 1N and 1D services with a decentralized serverless infrastructure, consisting of peer nodes that can become online or offline at unpredictable times.

It is another object of the present invention to provide methods to enable a 1N service without acquiring additional numbers as the public numbers for subscribers, whenever possible. This is in contrast with existing centralized solutions such as GrandCentral which require the acquisition of a new phone number for each subscriber.

It is yet another object of the present invention to enable a grassnode 1D service provider to provide sign-up, sign-on, and profile transfer for a user, without active participation from a user.

It is yet another object of the present invention to enable a grassnode 1D service that does not require a corresponding Web site to support particular protocols such as those specified by OASIS, OpenID, and other compatible organizations.

In accordance with one aspect of the present invention, both 1N and 1D services are provided through a decentralized database hosted on a serverless infrastructure. In the case of 1N service, the database is used to store the public phone numbers and registered reachable phone numbers for subscribers. In the case of 1D service, the database is used to store the user profile information (grassnode user-ID, activity lists, contact lists, and other profile information) for subscribers.

In accordance with another aspect of the present invention, a search algorithm based on DHT is used to search a distributed database to locate nodes that host the needed information, enabling a scalable and fast access to information.

In accordance with yet another aspect of the present invention, a signaling and routing system is used to route calls for a grassnode 1N service that will minimize the calling charges to the grassnode 1N provider.

In accordance with one aspect of the present invention, a phone number is an item from, while not restricted to, the following list: a PSTN phone number, a PLMN (Public Land Mobile Network) phone number, a VoIP (voice or video over IP) phone number, a text messaging account, an online presence account, or an email account.

In accordance with yet another aspect of the present invention, a box called grassnode with one port connecting to the Internet and another port connecting to a PSTN or PLMN line (in the case of PLMN, the grassnode is equipped to make mobile cellular calls) is a basic building block of a grassnode 1N network. For grassnode 1D networks, a basic building block (also called grassnode) only needs to be connectable to the Internet. These grassnodes are the peer nodes in overlay networks that implement grassnode 1N or 1D or both services.

In accordance with one aspect of the present invention, a search algorithm is used to locate a 1D grassnode that contains the profile information of a user. This grassnode will serve as a proxy and a trusted party to conduct trusted sign-on, sign-up, and profile transfer with a Web site.

In accordance with yet another aspect of the present invention, the profile of a grassnode 1D user contains, while not being restricted to: grassnode user-IDs, account names, account passwords, contact lists, and activity lists.

In accordance with yet another aspect of the present invention, a grassnode user-ID of a user is not globally unique at all Web sites, and a mapping is used to transform a grassnode user-ID to admissible Web site-specific IDs.

### BRIEF DESCRIPTION OF THE DRAWINGS

The above and other objects and features in accordance with the present invention will become apparent from the following descriptions of embodiments in conjunction with the accompanying drawings, and in which:

FIG. 1 sets forth the setup configuration of a 1N grassnode service for a user who owns a PSTN line directly connecting to a grassnode;

FIG. 2 depicts the process of a caller calling a subscriber of grassnode 1N service while the subscriber owns a PSTN line directly connecting to a grassnode;

FIG. 3 sets forth the setup configuration of a 1N grassnode service for a user who does not own a PSTN line directly connecting to a grassnode and uses a grassnode VoIP number as his PN;

FIG. 4 depicts the process of a caller using a phone set directly connected to a grassnode calling a 1N subscriber who does not own a PSTN line directly connected to a grassnode;

FIG. 5 depicts the process of a caller using a phone set directly connected to a grassnode calling a 1N subscriber who does not won a PSTN line directly connected to a grassnode, and registered phones ring serially;

FIG. 6 shows the reverse-proxy setup and the process of using OpenID protocol to sign up or sign on to a Web site;

FIG. 7 shows the proxy setup and the process of using grassnode 1D service to sign up or sign on to a Web site.

### DETAILED DESCRIPTION OF EXEMPLARY EMBODIMENTS

A fundamental novelty of the present invention is the unique combination of two concepts: (1) a decentralized infrastructure without servers and (2) a novel telecommunication identifier management system to offer One-Number (1N) and One-ID (1D) services.

The decentralized architecture is based on an emerging distributed computing paradigm resulting from a breakthrough in DHT-based directory search algorithms (notably Chord, Tapestry and Pastry). As this is a major development, a working group within IETF (Internet Engineering Task Force) has been set up to draft a complete set of standards for P2P-SIP (peer-to-peer session initiation protocol). Since P2P-SIP is only one special case of generic distributed computing, to those skilled in the art, a serverless infrastructure can be designed using DHT-based search algorithms without utilizing the forthcoming P2P-SIP standards. A key characteristic of such decentralized infrastructure is that both control and data plane operations are conducted in a peer-to-peer (P2P) manner.

It should be noted that while OpenID promoters claim that their architecture is decentralized without central servers, the fact is every OpenID service provider must erect a decentralized set of servers. To locate a server for OpenID operations, the architecture uses a hierarchical service discovery process. For example, a discovery provider for OpenID is often implemented via a DNS (domain name server) system, a key architectural component of the current Internet. DNS systems are hierarchical.

On the other hand, a grassnode 1D service uses DHT-like search algorithms to discover a generic (low-resource or not) box to act as a proxy for a user. A DHT-based decentralized architecture is completely flat in the sense that no servers are considered to be more important than others; while in a hierarchical decentralized architecture, a server in a higher position in the hierarchy is more important than a server in a lower position.

In accordance with one aspect of the present invention, both 1N and 1D services are provided through a decentralized DHT-based infrastructure, which is basically a distributed database. In the case of 1N, the database will store the locations (IP addresses) of grassnodes that contain the public phone numbers and the registered phone numbers associated with a subscriber. In the case of 1D, the database will store the locations (IP addresses) of grassnodes that contain the user-ID, user profile, and other user-specific information associated with a subscriber. A DHT-like search algorithm is used to search the distributed database in a P2P manner without any centralized servers or a hierarchy of servers. The process to locate the needed information in such a grassnode network is called signaling.

There are slight differences between the decentralized infrastructures for 1N and 1D. In both cases, an embodiment of the infrastructure is realized by an overlay network of peer nodes connected to the Internet. These nodes are volatile, as each node can attach or detach from the Internet unpredictably. These nodes are referred to as grassnodes. In the case of 1N, a grassnode will often be equipped with a port connecting to a PSTN or PLMN line. In the case of 1D, no such requirement is needed.

According to an embodiment of a grassnode 1N service, a grassnode is a box that has ports connecting to both the Internet and a PSTN or PLMN line. Further, a grassnode is also equipped with the functionality of IP-PBX (Private Branch Exchange), which allows for the routing of voice or video calls between the Internet and a PSTN or PLMN network.

According to yet another embodiment of a grassnode 1N or 1D or 1N-1D joint service, a grassnode can be embedded as a software module into smartphones, MIDs (mobile Internet device), PDAs (portable digital assistant), or any handheld devices that have a wireless radio connectable to the Internet. At the time of this application, devices such as iPhone and Google phone (G1) are prominent examples.

According to an embodiment of a grassnode 1N service, the network of grassnodes also provides a VoIP (voice or video over IP) service, in addition to the 1N service. In this scenario, users of the grassnode VoIP service would also benefit from the 1N service, allowing them to be reachable at multiple devices via one single number.

Hereafter, a phone number can be an item from the following list: a PSTN phone number, a PLMN phone number, a VoIP (voice or video over IP) phone number, a text messaging account, an online presence account, or an email account. Hereafter, making a call to such a phone number can be interpreted as making an ordinary phone call, or a VoIP phone call, or sending a text message, or sending an email. In a similar way, hereafter, a ring can be an ordinary telephone ring, or a signal to indicate that a VoIP call is forthcoming, or the arrival of a new text message, or the arrival of an email in an email server. Likewise hereafter, picking up a call can refer to literally picking up of an ordinary or VoIP call, or reading a text message, or downloading an email. In all these terms, the textual context will help determine the meaning precisely.

In addition, hereafter, the terms subscriber and user are used interchangeably.

Fundamentally, a 1N service is a call-forwarding service. Therefore, in order for a grassnode network to accomplish call forwarding, a call to a PN must be intercepted by a grassnode. This leads to the requirement that a PN must either be a PSTN number directly connected to a grassnode, or a grassnode VoIP number. Once a call is intercepted by a grassnode, the network reroutes the call to desired devices.

This requirement leads to two forms of 1N service: unrestricted and restricted. An unrestricted service is the same as an ordinary one-number service. A subscriber can use an unrestricted service only if he owns a PSTN or a PLMN line directly connected to a grassnode. A subscriber with an unrestricted 1N service will be referred to as an unrestricted subscriber. In one embodiment of the present invention, a grassnode connected to a PSTN or a PLMN line is implemented by a standalone box with one Internet port and another PSTN or PLMN port. In another embodiment of the present invention, a grassnode connected to a PLMN line is implemented by adding the grassnode software directly onto a cellular PLMN phone. Such phone would also have Internet connectivity, e.g. via a WiFi antenna, GPRS, EDGE, 3G or HSDPA. Examples of such phones available today in the market are the iphone and the G1.

A restricted 1N service, on the other hand, is for a subscriber who does not own a PSTN or a PLMN line directly connected to a grassnode. In order to have calls forwarded, such a subscriber must choose a grassnode VoIP number to be his PN. Such a subscriber will be referred to as a restricted subscriber.

There will be restrictions imposed on how a caller can reach a restricted subscriber. One obvious restriction is that a caller must make a VoIP call to reach a restricted user (as the PN of a restricted subscriber is always a VoIP number). This restriction can be lessened to also allow a caller who has access to a PSTN or PLMN line directly connected to a grassnode. One example is the case when a caller is an unrestricted subscriber; he can make a call to a restricted subscriber by using the phone set that is directly connected to a grassnode.

Indirect dialing can also be used. Indirect dialing is a common technique used by calling card companies. With this method, a caller first dials a PSTN number (which is directly connected to a grassnode); then after being connected to that number, the caller enters the PN (a grassnode VoIP number) of a desired restricted subscriber. With indirect dialing, there is no requirement that a caller must use a phone set directly connected to a grassnode; the caller can use any phone device.

According to an embodiment of a grassnode 1N service, an unrestricted subscriber sets the phone number of his PSTN or PLMN line directly connected to a grassnode as his PN. For a restricted subscriber, he must obtain a grassnode VoIP number from a grassnode 1N service as his PN.

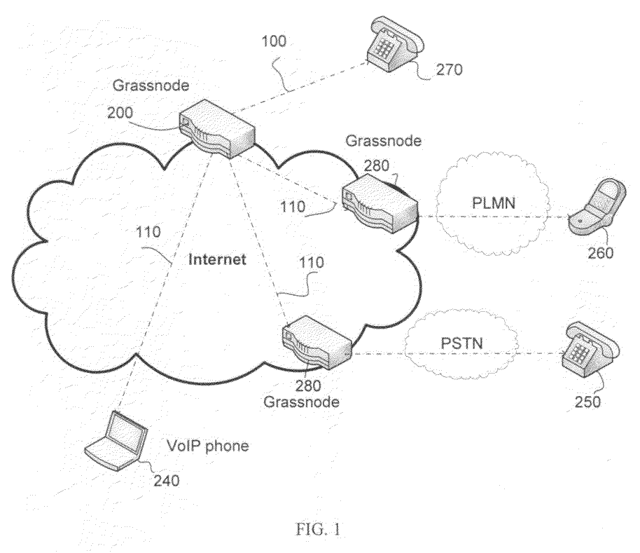

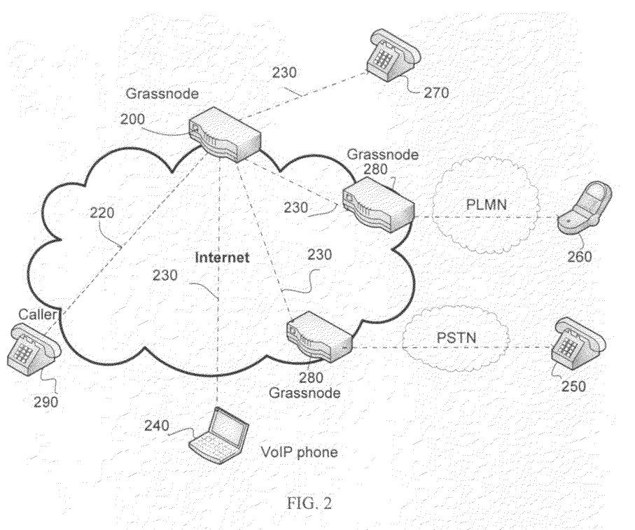

According to another embodiment of a grassnode 1N service, the setup and event flow for an unrestricted subscriber are as follows. The subscriber registers his PN and reachable phone numbers (all forms) with a grassnode 1N service. The 1N service will assign the grassnode that is directly connected to his PN line to store the set of registered numbers for the user; such a grassnode will be called the host grassnode for the subscriber. When a caller makes a call to a PN, the host grassnode broadcasts the call to the devices associated with the registered phone numbers. As the subscriber is informed through at least one of the devices associated with the registered phone numbers, he then chooses one of the devices to pick up the call. Once the subscriber picks up the call, the devices associated with the rest of the registered phone numbers stop ringing. The setup phase of this scenario is illustrated in FIG. 1; the event flow for a call is illustrated in FIG. 2.

As depicted in FIG. 1, a user's host grassnode 200 is connected directly to a desk phone 270 through a phone cord; the user sets his PN to be the PSTN phone number associated with the phone 270. The user also sets his registered numbers to be associated with a VoIP client in a laptop 240, his office desk phone 250, and his PLMN cell phone 260. The connections 110 between a grassnode 200 to other grassnodes 280 and the devices could be an Internet channel (laptop), an Internet-PLMN combination line, or an Internet-PSTN combination line.

As depicted in FIG. 2, a caller uses a phone 290 to call a PN. There are two cases in this scenario. In the first case, if the caller phone 290 is a PSTN or PLMN phone, then the call will be routed directly through a PSTN connection 220 to the desk phone 270. The grassnode 200 will intercept the call (as the PSTN line for desk phone 270 is directly connected to grassnode 200); and it will then broadcast to all the registered devices 270, 260, 250, and 240, through the various links 230. In the second case, if the caller phone 290 is a VoIP phone, then the call will be routed to grassnode 200 through an Internet connection. The rest of the operations will be the same as in the first case. It is important also to notice that grassnodes 280 are responsible to translate the call coming from lines 230 (typically Internet lines) through a PSTN (or PLMN) to reach terminal 250 (or 260). This is possible since according to one embodiment of the present invention, these grassnodes are both (1) equipped with IP and PSTN/PLMN ports and (2) they are also loaded with an IP-PBX software suite capable of doing such translation (in both directions, i.e. packet-to-circuit and a circuit-to-packet translations).

According to one embodiment of a grassnode 1N service, a user can also register his phone numbers with a software download. For instance, a user can download grassnode 1N software into his laptop, or a smartphone, or a mobile device with an Internet connection; then the grassnode software will do automatic registration for the user, after authentication.

According to another embodiment of a grassnode 1N service, a user can also register his phone numbers using a web browser interface to connect to a web server, which will do the registration of the numbers into the grassnode 1N service.

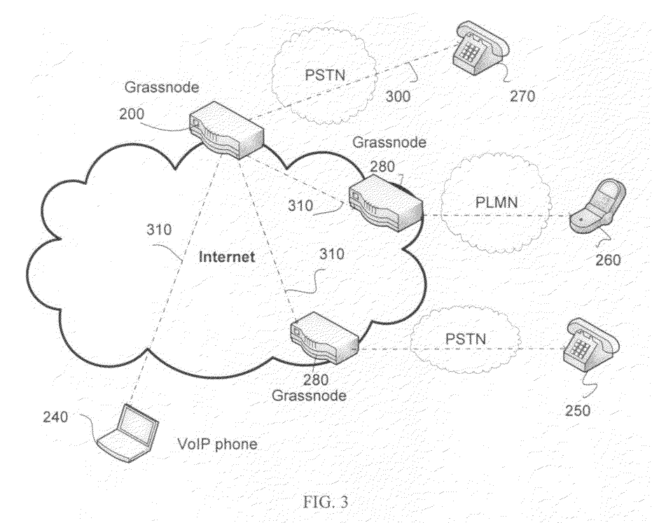

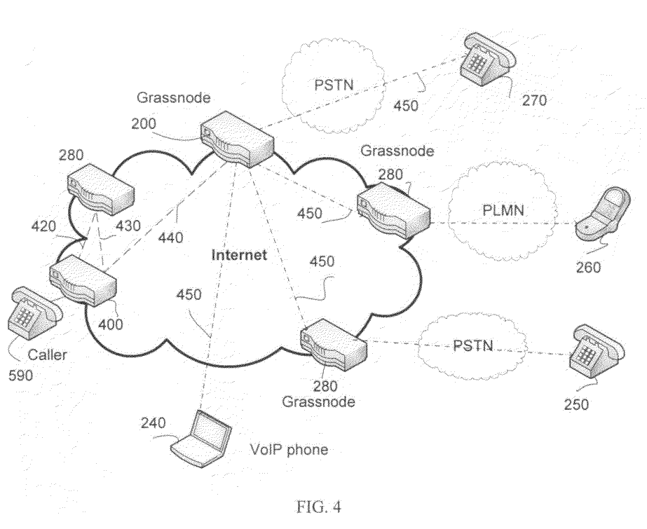

According to one aspect of the present invention, the setup and event flow for a restricted subscriber are as follows. The restricted subscriber registers his PN and reachable phone numbers (all forms) with the grassnode network through an Internet connection. Again, the grassnode service assigns a host grassnode for the restricted user. When a caller makes a call to a PN, the grassnode network broadcasts, through the host grassnode, the call to all devices associated with the registered phone numbers, using a multi-hop routing protocol (an objective of such routing is to minimize the calling charges, for example). As the subscriber is informed of a forthcoming call, he then chooses one of the devices associated with the registered phone numbers to pick up the call. Once the subscriber picks up the call, the devices associated with the rest of the registered numbers stop ringing. The setup for a restricted user is illustrated in FIG. 3; the event flow for a call made from a phone set directly connected to a grassnode to a restricted user is illustrated in FIG. 4.

As depicted in FIG. 3, a user sets a grassnode VoIP number as his PN, and the grassnode network chooses a particular grassnode 200 to be his host grassnode. At grassnode 200, registered numbers—270 (a desk phone), 260 (a cell phone), 250 (another desk phone), and 240 (a grassnode VoIP phone, which is his PN)—are maintained. The connection methods to reach these phone numbers through the links 300 and 310 are also maintained at grassnode 200.

FIG. 4 depicts a situation wherein a caller uses a phone set 590 directly connected to grassnode 400 to call a restricted user. When a caller makes a call, the call will be intercepted at grassnode 400. Then through a grassnode network routing protocol, using control signaling of the grassnode 1N network, grassnode 400 locates grassnode 200 which hosts the associated registered numbers for the restricted user. In the example, node 400 exchanges messages 420 and 430 with another node 280 to find the location of node 200. Such kind of collaboration between nodes (which in general could involve any number of nodes until the query is resolved) is used to resolve the routing problem. This signaling is needed since each grassnode only has a partial knowledge of the entire grassnode network. After node 400 finds the location of node 200, the call is then routed to grassnode 200; and through the various links 450, registered devices 270, 260, 250, and 240 are reached.

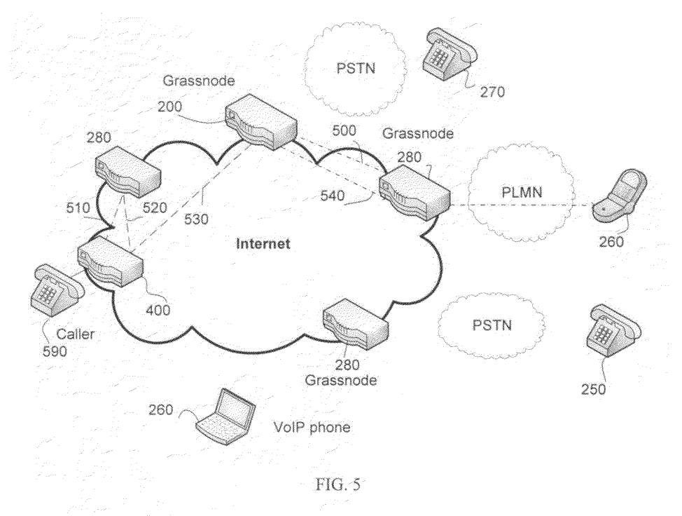

In yet another embodiment of a grassnode 1N service, a subscriber chooses to have only one device to ring at a time; such service is called pointcast. In this embodiment, when a caller calls a PN, the grassnode network will forward the call serially to the devices associated with the registered phone numbers according to a pre-specified sequence. An example of the event flow of a call is illustrated in FIG. 5.

FIG. 5 depicts the same situation as in FIG. 4 except that the registered numbers are routed in a pre-specified sequence. Again, in this figure, the caller is using a phone device 590 directly connected to grassnode 400. The grassnode that hosts the registered phone number for the restricted subscriber is 200. Assuming that, according to the pre-specified sequence, the user decides to have only his cell phone 260 registered as a callable number; then through grassnode network signaling (510, 520), grassnode 400 routes the call to grassnode 200, which in turn routes the call to the grassnode that will route the call to the cell phone 260. The routing decision can also be based on certain criteria such as minimization of end-to-end calling charges.

According to an embodiment of a grassnode 1D service, a grassnode is a box that has a port connecting to the Internet. In particular, a grassnode box can be a handheld device with a wireless connection to the Internet.

According to an embodiment of a grassnode 1D service, each subscriber is provided with a grassnode 1D account, which is stored in a grassnode 1D distributed database, in multiple copies distributed over several grassnodes. For each copy, the 1D account of a subscriber stores account names, passwords, contact lists, activity lists, and other profile information specific to the subscriber.

According to an embodiment of a grassnode 1D service, a grassnode 1D account implements sufficient functionalities of the OpenID protocol suite in order to qualify the grassnode service to operate as an OpenID service provider.

According to an embodiment of a grassnode 1D service, a grassnode is further programmed to support a select set of protocols specified by OASIS, or other compatible social-networking protocols.

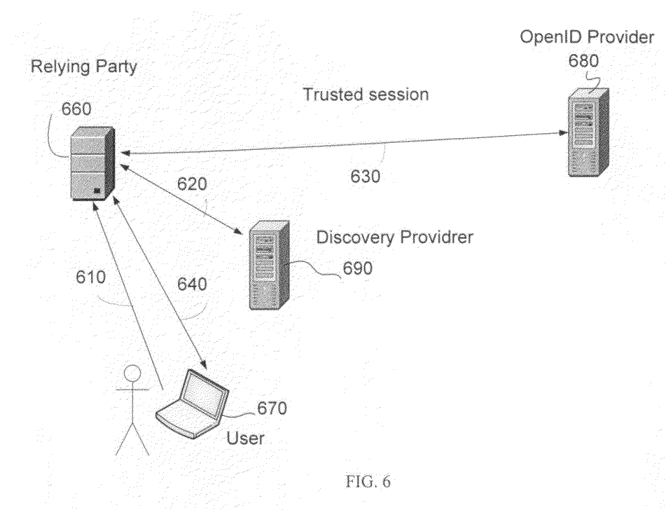

It is instructive to provide an architectural overview and event flow for an OpenID service in comparison with a grassnode 1D service. FIG. 6 depicts the event flow. In event 610, a user 670 initiates authentication by supplying an identifier in the form of an URL (uniform resource locator) to an RP (relying party, basically a site to sign on) 660. In event 620, the relying party then performs discovery. Often with the help of a discovery provider, an XRDS (extensible resource descriptor sequence) document associated with the URL is discovered. The XRDS document will help determine an OpenID service provider, and the type of OpenID services supported with this provider and for the user. In event 630, the relying party and the OpenID provider establish a shared secret through the use of a Diffie-Hellman key exchange, and admit subsequent messages with this key. The relying party requests authentication for the user; while the identity provider determines whether the end user is authorized to perform OpenID authentication. This approach is known as reverse-proxy (or server-proxy) architecture because it is the relying party (server) and not the client (user) that relies on a proxy to complete a transaction. In contrast, in a client-proxy (or user-proxy) approach, a client user will communicate to a server via a proxy.

At the end of event 630, the relying party verifies the information received from the OpenID provider by verifying the discovered information and the signature using the established shared key. In event 640, the user is authenticated (either for sign-up or sign-on) and normal operations proceeds.

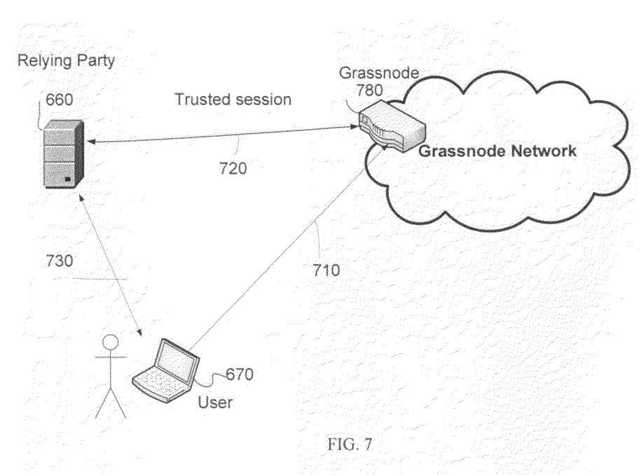

In contrast, a grassnode event flow for an authenticated sign-up or sign-on is as follows (depicted in FIG. 7). In event 710, a user 670 sends a sign-up or sign-on request to a grassnode 1D service provider through an Internet connection with a grassnode user-ID and a message detailing the services needed (for example, sign-on or sing-up, with profile transfer or not). The grassnode 1D service provider, through a distributed database search, discovers a grassnode 780 that contains the user profile information. At the end of event 710, grassnode 780 authenticates the user 670, and starts a trusted session with the relying party for sign-up or sign-on, constituting event 720. This trusted session can be implemented via a Diffie-Hellman key exchange. In the trusted session, grassnode 780 proceeds to sign up or on for the user, and conduct user profile transfer if requested by the user. In event 730, the user 670 is authenticated, signed up or on, and normal operations proceed.

The grassnode 1D service differs from the OpenID in that it uses a user-proxy method rather than the reverse-proxy approach taken by OpenID. Further, a grassnode 1D service implements the proxies not by using a single proxy node, or a hierarchy of proxy nodes (the approach of OpenID), but rather by leveraging on a serverless infrastructure of grassnodes. From a logical perspective, a grassnode network as a whole can be understood as a single proxy system. In some embodiments of the present invention, such network of distributed grassnodes perform the functions of both 1N and 1D services, thus maximizing the leverage of the system.

In yet another embodiment of a grassnode 1D service, a user's computer and the grassnode that serves to authenticate the user is one and the same.

In one embodiment of a grassnode 1D service, a subscriber is allowed to use a globally non-unique user-ID of his choice as his grassnode ID. To resolve naming conflicts at a site, the grassnode 1D service does a mapping between a grassnode user-ID and a site-specific ID to resolve naming conflicts therein. An admissible site-specific ID is an account ID that passes the uniqueness test of an Internet-based organization, independent of the particular site wherein a user conducts his login.

Mathematically, the mapping between grassnode user-ID and site-specific ID is described by the function and reverse function: f_g (GID)=SID and f_s(SID)=GID, wherein f_g(.) is the function mapping a grassnode user-ID denoted by GID to a site-specific ID, denoted by SID, and f_s(.) is the function mapping a site-specific ID into a grassnode user-ID. The only requirements for these functions are: (1) both f_g(.) and f_s(.) are 1-to-1 mappings, and hence reversible, (2) the dimension of the range space of f_g(.) is significantly larger than the dimension of the domain space of f_g(.), so that the chance of the SID generated through f_g(.) by any random GID is unique at a site is extremely high.

In yet another embodiment of a grassnode 1D service, a site-specific ID is created by inserting alphanumeric digits into a grassnode user-ID. In particular, a site-specific ID is created by adding a prefix or a suffix or both to an original grassnode user-ID. For example, Eric_Smith as a user-ID can be mapped to a site-specific ID such as G1D_Eric_Smith_{—}22 or Eric_Smith_G1D22.

It should be noted that OpenID uses a similar concept. In an OpenID service, a globally unique (or site-specific and site-unique) ID is a concatenation of two IDs: XRI (extensible resource identifier) “i-names” and XRI “i-numbers.” An XRI “i-name” is recyclable; i.e., it is not required to be globally unique. By appending an XRI “i-number” to an XRI “i-name,” the resulting ID will be globally unique. Therefore, the grassnode 1D mapping is a more generic form of generating globally unique ID at different sites.

In yet another embodiment of a grassnode 1D service, a file transfer module at a grassnode is programmed to transfer user profile from the grassnode 1D service to transferrable sites. A site is said to be transferrable if the site allows profile transfer, and the transfer module has been programmed according to the requirements of the allowed transfer. Such a transfer is programmed to allowing no active participation from the subscriber desiring such a service, whenever possible.

What is claimed is:

1. A method to offer One-Number service with a peer-to-peer network, comprising:
a plurality of volatile peer nodes called grassnodes, forming an overlay network;
a plurality of public phone numbers called PNs, one for each subscriber;
a plurality of registered phone number, one set for each subscriber of said service;
wherein each said nodes may attach to or detach from said overlay in an unpredictable manner; each said phone number is associated with a device; said public numbers and registered phone numbers are stored in a distributed database hosted in a plurality of peer nodes; and searching for the locations of such devices associated with said phone numbers are conducted through a DHT-based algorithm.

2. The method of claim 1, wherein a said phone number is a member of the list: a PSTN phone number, a PLMN phone number, a voice over IP phone number, a video over IP phone number, a text messaging account, an online presence account, or an email account.

3. The method of claim 2, wherein each said grassnode has a connection to the Internet, and has an option to connect to a PSTN or PLMN phone line. In particular, a said grassnode can be a handheld device with a wireless Internet connection.

4. The method of claim 3, wherein said overlay network also provides a voice over IP or a video over IP service or both.

5. The method of claim 4, wherein each said subscriber sets the phone number of a PSTN or PLMN line directly connecting to a grassnode to be his public number, or a VoIP number serviced by said overlay network to be his public number.

6. The method of claim 5, wherein each said grassnode is programmed to perform circuit-to-packet translation, packet-to-circuit translation, and a set of essential IP-PBX functions. Such functions are used to perform call forwarding, along with signaling, for calls reaching a device associated with said registered phone numbers in said overlay network.

7. The method of claim 6, wherein a caller calls the PN of a said subscriber, all devices associated with the registered phone number will indicate that a call, text message, or an email has been initiated or arrived through broadcast messages sent through said overlay network.

8. The method of claim 7, wherein a caller calls the PN of a said subscriber, all devices associated with the registered phone number will indicate that a call, text message, or an email has been initiated or arrived, serially according to a pre-specified order of notifications.

9. A computer-readable medium with a computer program for performing the method as described in any one of claims 1 to 8.

10. A method to offer One-ID service with a peer-to-peer network, comprising:
a plurality of volatile peer nodes called grassnodes, forming an overlay network;
a user-ID called grassnode ID, one for each subscriber of said service;
a user profile consisting of personal information (with account names and associated passwords), contact lists, and activity list, one for each said subscriber;
wherein each said nodes may attach to or detach from said overlay in an unpredictable manner; each said user profile is stored in a distributed database hosted over a plurality of said nodes in a plurality of copies; and searching for such a grassnode storing for a said subscriber is conducted through a DHT-based algorithm.

11. The method of claim 10, wherein the following operations are performed to establish an authenticated sing-up, sign-on or profile transfer with a Web site by a said subscriber:
a said subscriber locates a grassnode storing his profile;
said grassnode is notified to initiate an authenticated sign-up, sign-on or profile transfer with a Web site for said subscriber;
said grassnode establishes a trusted session with said Web site, and perform said authenticated sign-on, sign-up, or profile transfer for said subscriber.

12. The method of claim 11, wherein a said grassnode ID is mapped into a site-specific ID via a function f_g(.), wherein f_g(GID)=SID, GID denotes a grassnode ID, SID denotes a site-specific ID, while the only restriction on f_g(.) is that it is a 1-to-1 function, and the dimension of the range space of f_g(.) is much larger than the dimension of the domain space of f_g(.).

13. The method of claim 12, wherein a said site-specific ID is generated from a grassnode ID by appending a prefix, or a suffix, or both to said grassnode ID.

14. The method of claim 13, wherein a said grassnode implement a subset or full set of compatible protocols associated with OpenID and OASIS; further, said overlay network of grassnodes also serves as a provider of OpenID, OASIS related services.

15. The method of claim 14, wherein a said user's computer and a said grassnode that serves to authenticate said user is one and the same.

16. The method of claim 15, wherein said grassnodes are programmed to keep user profiles and to conduct user profile transfers to sites that accept automatic transfer of user profiles.

17. A computer-readable medium with a computer program for performing the method as described in any one of claims 10 to 16.
